(19) United States
(12) Patent Application Publication
(10) Pub. No.: US 2007/0028518 A1
(43) Pub. Date: Feb. 8, 2007

(54) Collapsible floral container

(76) Inventor: Donald E. Weder, Highland, IL (US)

Correspondence Address: DUNLAP, CODDING & ROGERS P.C., PO BOX 16370, OKLAHOMA CITY, OK, 73113, US

(21) Appl. No.: 11/543,748

(22) Filed: Oct. 5, 2006

Related U.S. Application Data
(63) Continuation of application No. 10/932,355, filed on Sep. 1, 2004, now abandoned.
Application No. 10/932,355 is a continuation of application No. 10/434,141, filed on May 8, 2003, now abandoned.

(51) Int. Cl. A01G 9/02

(52) U.S. Cl. 47/72

(57) ABSTRACT

A collapsible floral container stored and shipped in a substantially planar configuration and expanded into the form of a flower pot or flower pot cover is disclosed. The collapsible container includes a plurality of segments and a connecting member for connecting the segments such that the segments define a sidewall and such that the segments are movable between an expanded position wherein the segments cooperate with one another to form an object receiving space and to provide the sidewall with a unitary appearance and a collapsed position wherein the sidewall is substantially flattened.

### CROSS-REFERENCE TO RELATED APPLICATIONS

This application is a continuation of U.S. Ser. No. 10/932,355, filed Sep. 1, 2004, now abandoned; which is a continuation of U.S. Ser. No. 10/434,141, filed May 8, 2003, now abandoned; which claims the benefit under 35 U.S.C. 119(e) of U.S. Provisional Application Ser. No. 60/212,572, filed Jun. 20, 2000; the contents of each of which are hereby expressly incorporated herein by reference in their entirety.

### STATEMENT REGARDING FEDERALLY SPONSORED RESEARCH OR DEVELOPMENT

Not applicable.

### BACKGROUND OF THE INVENTION

1. Field of the Invention

The present invention relates generally to collapsible containers, and more particularly, but not by way of limitation, to a collapsible flower pot or flower pot cover that is ceramic or has a ceramic appearance.

2. Brief Description of the Related Art

Flowers and other plants have long been grown and displayed in pots, commonly referred to as “flower pots”. Flower pots are generally constructed of natural, earthen material, such as clay, which is in turn glazed and fired to produce a harden, non-flexible ceramic structure. Flower pots have also been constructed of plastic materials which are colored or painted to have the appearance of an earthen material.

While clay or ceramic flower pots are both aesthetically pleasing and effectively serve the purpose of containing plant material and a growing medium, inefficiencies are nevertheless experienced in shipping and storing such containers due to the their bulkiness and susceptibility to breakage. More specifically, ceramic flower pots are rigid but at the same time are quite fragile. Because of their rigidity, a large volume of space is required for both shipping and storing ceramic flower pots which results in high shipping and storage costs. Their inflexibility further results in increased losses due to breakage.

To prevent breakage, large amounts of dunnage material is required, which also results in higher costs. While breakage is not so much a problem with plastic flower pots, plastic flower pots nevertheless require a significant amount of space for storage and shipment.

To this end, a need exist for a flower pot that can be shipped and stored in a substantially flattened condition and readily erected into a container that can hold a growing medium and plant material and that has a ceramic appearance. It is to such an invention that the present invention is directed.

### BRIEF DESCRIPTION OF THE DRAWINGS

FIG. 1 is a perspective view of a collapsible container constructed in accordance with the present invention shown disposed about a flower pot.

FIG. 2 is a side elevational view of the collapsible container of FIG. 1 shown in a collapsed condition.

FIG. 3 is an end elevational view of the collapsible container of FIG. 1 shown in the collapsed condition.

FIG. 4 is a perspective view of a flexible liner in an expanded condition.

FIG. 5 is a plan view of a portion of another embodiment of a collapsible container constructed in accordance with the present invention showing the hinged connection of two rigid segments of the collapsible container.

FIG. 6 is a top plan view of a collapsible container constructed in accordance with the present invention shown in a collapsed condition.

FIG. 7 is a top plan view of the collapsible container of FIG. 6 shown in an expanded condition.

FIG. 8 is a top plan view of another embodiment of a collapsible container constructed in accordance with the present invention shown in an expanded condition.

FIG. 9 is a top plain view of another embodiment of a collapsible container constructed in accordance with the present invention shown in a collapsed condition.

FIG. 10 is a plan view of a portion of another embodiment of a collapsible container constructed in accordance with the present invention showing the hinged connection of two rigid segments of the collapsible container with the collapsible container in a collapsed condition.

FIG. 11 is a top plan view of a portion of the collapsible container of FIG. 10 shown in an expanded position.

FIG. 12 is a plan view of a portion of two rigid segments constructed in accordance with the present invention.

FIG. 13 is a plan view of the two segments of FIG. 12 shown connected together.

FIG. 14 is an elevational view of another embodiment of a collapsible container constructed in accordance with the present invention.

FIG. 15 is a sectional view of another embodiment of a collapsible container constructed in accordance with the present invention.

FIGS. 16A-16E are plan views of various shapes of rigid segments used in constructing collapsible containers in accordance with the present invention.

FIG. 17 is a sectional view of another embodiment of a collapsible container constructed in accordance with the present invention.

FIG. 18 is a sectional view of another embodiment of a collapsible container constructed in accordance with the present invention.

FIG. 19 is a sectional view of another embodiment of a collapsible container constructed in accordance with the present invention.

FIG. 20 is a sectional view of another embodiment of a collapsible container constructed in accordance with the present invention.

FIG. 21 is a perspective view of another embodiment of a collapsible container constructed in accordance with the present invention.

FIG. 22 is a sectional view another embodiment of a collapsible container constructed in accordance with the present invention.

### DETAILED DESCRIPTION OF THE INVENTION

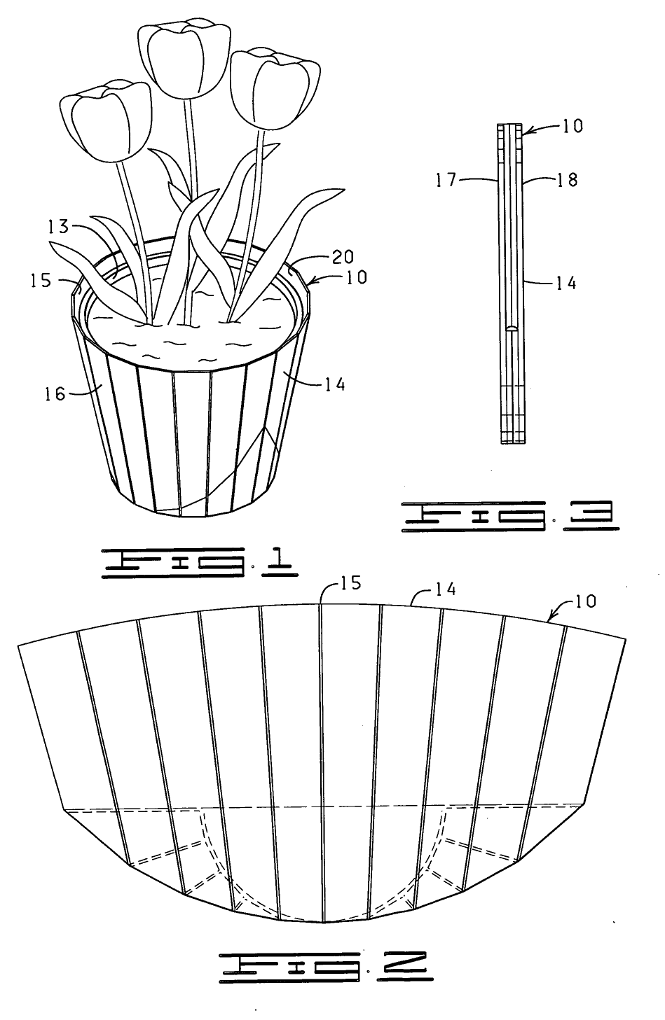

Referring now to the drawings, and more particularly to FIGS. 1-3, shown therein is a collapsible container 10 constructed in accordance with the present invention. The collapsible container 10 includes a plurality of rigid segments 14 and a connecting member 15 for connecting the rigid segments 14 such that the rigid segments 14 define a sidewall 16 and such that the rigid segments 14 are movable between an expanded condition (FIG. 1) and a collapsed condition (FIGS. 2 and 3). In the expanded condition, the rigid segments 14 cooperate with one another to form an object receiving space 20 and to provide the sidewall 16 with a unitary appearance. In the collapsed condition, the sidewall 16 is substantially flattened. The collapsible container 10 illustrated in FIG. 1 is in the expanded position and is configured to cover an object, such as a flower pot 13.

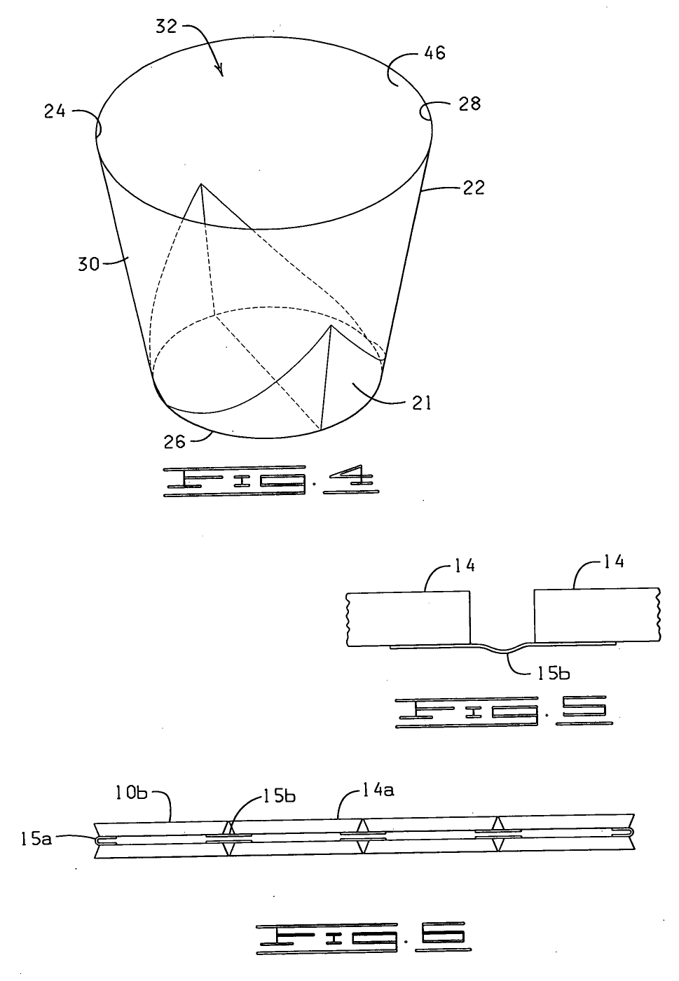

The connecting member 15 of the collapsible container 10 is illustrated as being a flexible liner 22. As best shown in FIG. 4, the flexible liner 22 has an open upper end 24, a closed lower end 26, an inner surface 28, an outer surface 30, and an object receiving space 32. The flexible liner 22 is provided with a gusset 21 to permit the flexible liner 22 to be moved between an expanded condition and a collapsed condition. The flexible liner 22 can be constructed from a suitable flexible and durable material, and preferably from a waterproof material to prevent leakage from the collapsible container 10. The bottom of the flexible liner 22 is illustrated as not being covered with rigid segments. However, it will be appreciated that the bottom of the flexible liner 22 can be provided with rigid segments.

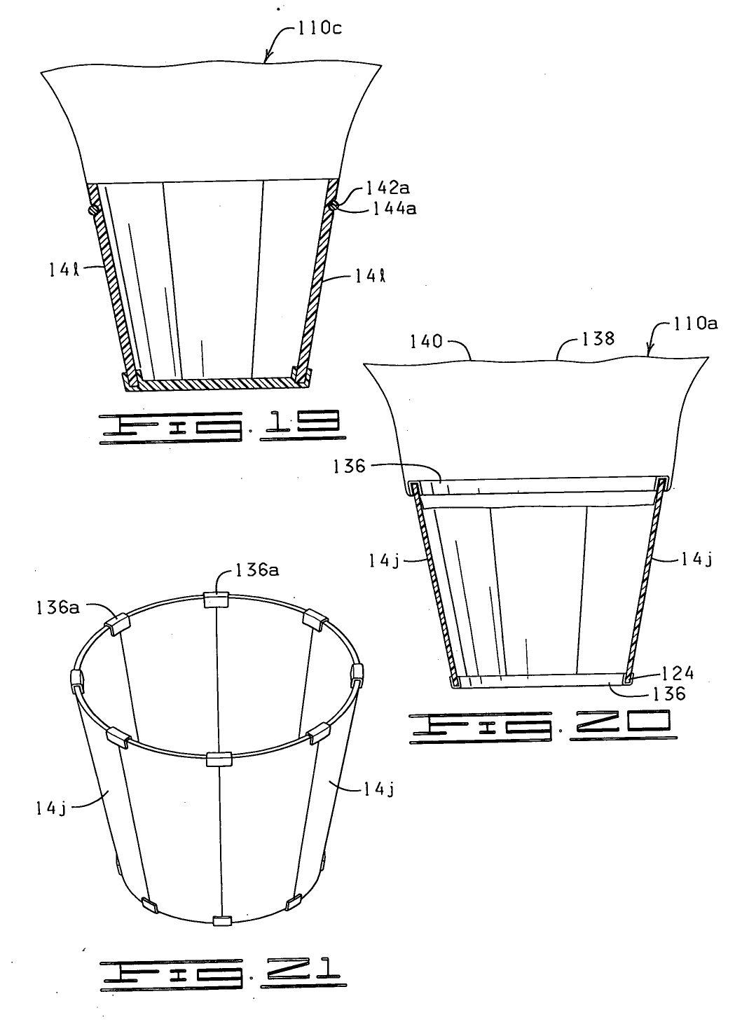

The rigid segments 14 of the collapsible container 10 are of a substantially planar configuration with square edges. However, the rigid segments can also be of a substantially curved configuration as shown in FIG. 16E or irregular configurations, as shown in FIG. 14, so as to provide a mosaic appearance. More specifically, FIG. 14 illustrates a collapsible container 10a which includes a plurality of rigid segments 33 attached to a connecting member 15a. The connecting member 15a is shown to be substantially similar to the connecting member 15 described above. In addition, the rigid segments can be provided with angled edges or tongued and grooved edges, as will be described below. The rigid segments 14 are constructed from a substantially rigid material, such as ceramic, clay, concrete, plastic, metal, wood, rock or combinations thereof. In addition, the rigid segments can be decorated in various colors, finishes and decorative designs.

The inner surface of the rigid segments 14 are fixed to the outer surface 30 of the flexible liner 22 via a bonding material. The rigid segments 14 are shaped and arranged so as to permit the rigid segments 14 to move between the expanded condition (FIG. 1) and the collapsed condition (FIGS. 2 and 3) in conjunction with the flexible liner 22. The rigid segments 14 of substantially planar or curved configurations are aligned on the flexible liner 22 such that longitudinal edge of one rigid segment 14 substantially parallels the longitudinal edge of the adjacent rigid segment 14. To this end, the flexible liner 22 serves as a hinge between the rigid segments 14 thereby allowing the collapsible container 10 to be moved between the expanded condition and the collapsed condition.

The collapsible container 10 is maintained in the expanded condition upon disposing the flower pot 13 into the object receiving space 20, or some other support member, such as soil.

FIGS. 5-9 illustrate that the rigid segments 14 can also be connected with a material that can be repeatedly flexed without fatiguing, such as polypropylene, so as to provide a living hinge. More specifically, FIG. 5 shows the rigid segments 14 connected with a connecting member 15b, and FIGS. 6-7 show a collapsible container 10b. The collapsible container 10b includes a plurality of rigid segments 14a and the plurality of connecting members 15b for connecting the rigid segments 14a such that the rigid segments 14a define a sidewall 16a and such that the rigid segments 14a are movable between an expanded condition (FIG. 7) and a collapsed condition (FIG. 6). In the expanded condition, the rigid segments 14a cooperate with one another to form an object receiving space 20a and to provide the sidewall 16a with a unitary appearance. In the collapsed condition, the sidewall 16a is substantially flattened. To provide a more unitary appearance, the ends of the rigid segments 14a are angled so that the ends of the rigid segments 14a abut in the expanded condition.

The connecting members 15b are illustrated as being an elastic living hinges wherein each living hinge has one portion connected to one of the rigid segments 14a and another portion connected to an adjacent rigid segment 14a. The connecting members 15b connect the inner surface of one rigid segment 14a together with the inner surface of the adjacent rigid segment 14a. The elasticity of the living hinges biases the rigid segments 14a in the expanded condition, yet permits the rigid segments 14a to be moved to the collapsed condition.

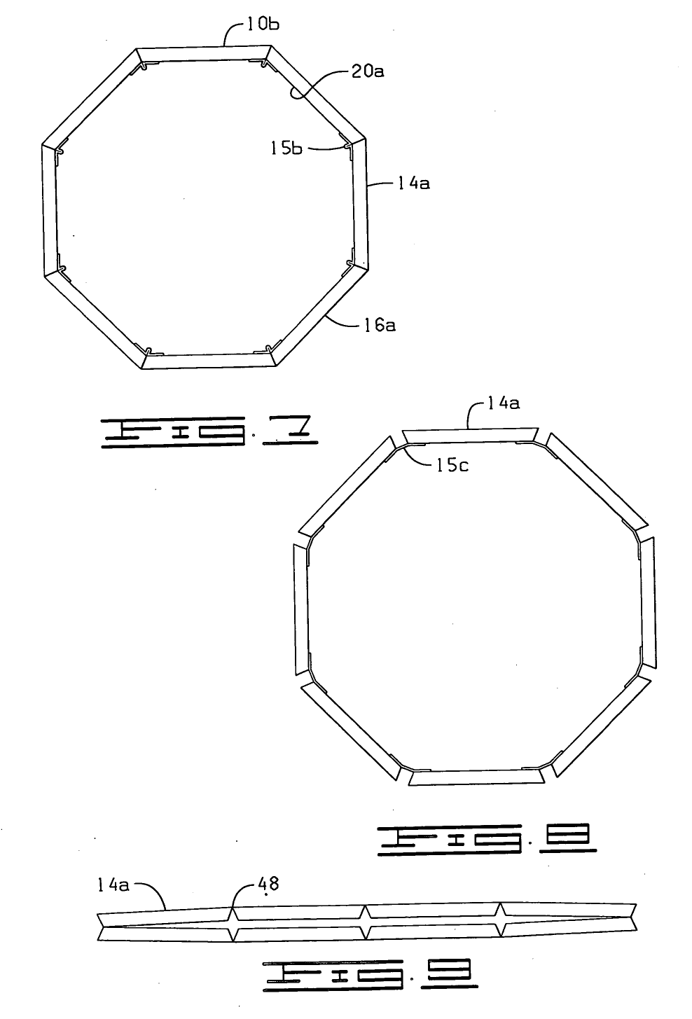

FIG. 8 illustrates a connecting member 15c which is non-elastic. As such, the rigid segments 14a are not biased in the expanded condition and the rigid segments 14a will be spaced apart in the expanded condition a sufficient distance to permit the rigid segments 14a to be moved to the collapsed condition.

As shown in FIG. 9, the rigid segments 14a can also be molded as a single piece with a thinned area or score line 48 provided between adjacent rigid segments 14a to permit the rigid segments 14a to expand and collapse relative to one another.

FIGS. 10 and 11 illustrate a portion of another embodiment of a collapsible container 10c which includes a plurality of rigid segments 14b and a plurality of connecting members 15c for connecting the rigid segments 14b such that the rigid segments 14b define a sidewall 16b and such that the rigid segments 14b are movable between an expanded condition (FIG. 11) and a collapsed condition (FIG. 10). The rigid segments 14b are provided with an arcuate configuration. The rigid segments 14b are further illustrated as having an inner lip 92 formed on one end and an outer lip 94 formed on the opposite end. The inner and outer lips 92 and 94 overlap so as to cooperate to interlock the rigid segments 14b in the expanded condition.

The connecting member 15c is an elastic member having one portion connected to one of the rigid segments 14b and another portion connected to an adjacent rigid segment 14b so as to bias the rigid segments 14b in the expanded condition, yet permit the rigid segments 14b to be moved to the collapsed position.

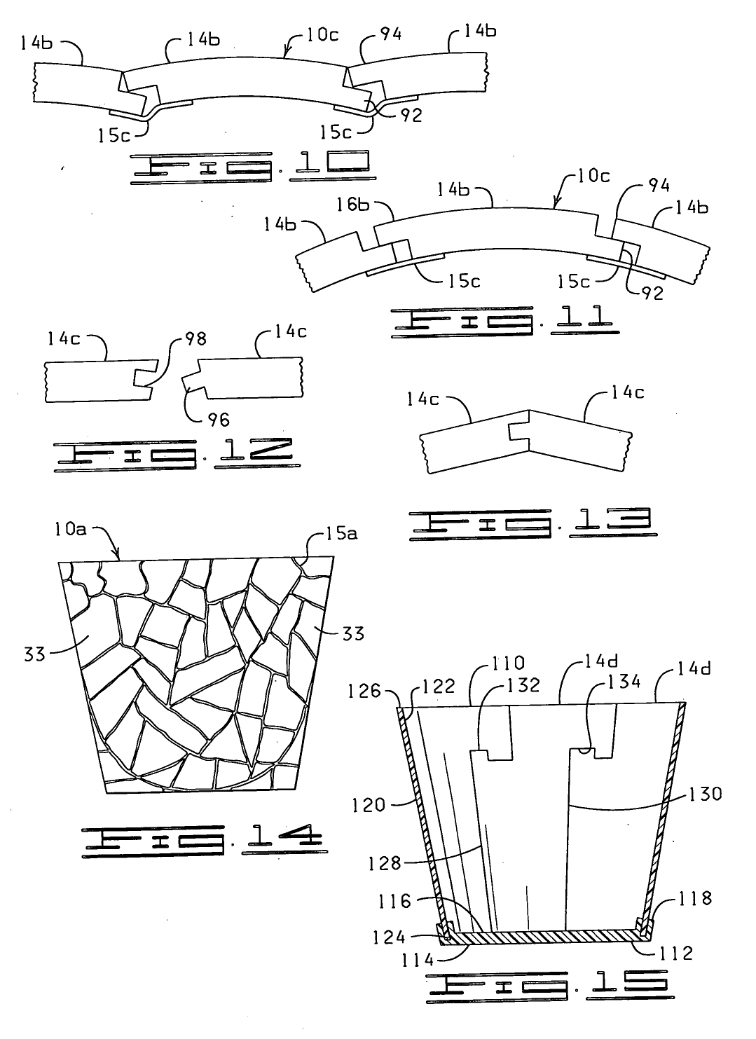

FIGS. 12 and 13 illustrate another embodiment of rigid segment 14c wherein the rigid segments 14c include a tongue 96 on one end and a corresponding groove 98 on the opposite end. The tongue 96 and groove 98 are configured to interlock together when the rigid segments 14c are in the expanded condition. These interlocking features provide the desired shape and add strength to the collapsible container in its expanded position.

FIGS. 16A-16E illustrate various other embodiments of rigid segments 14e-14i that can be utilized in construction of the collapsible container in accordance with the present invention.

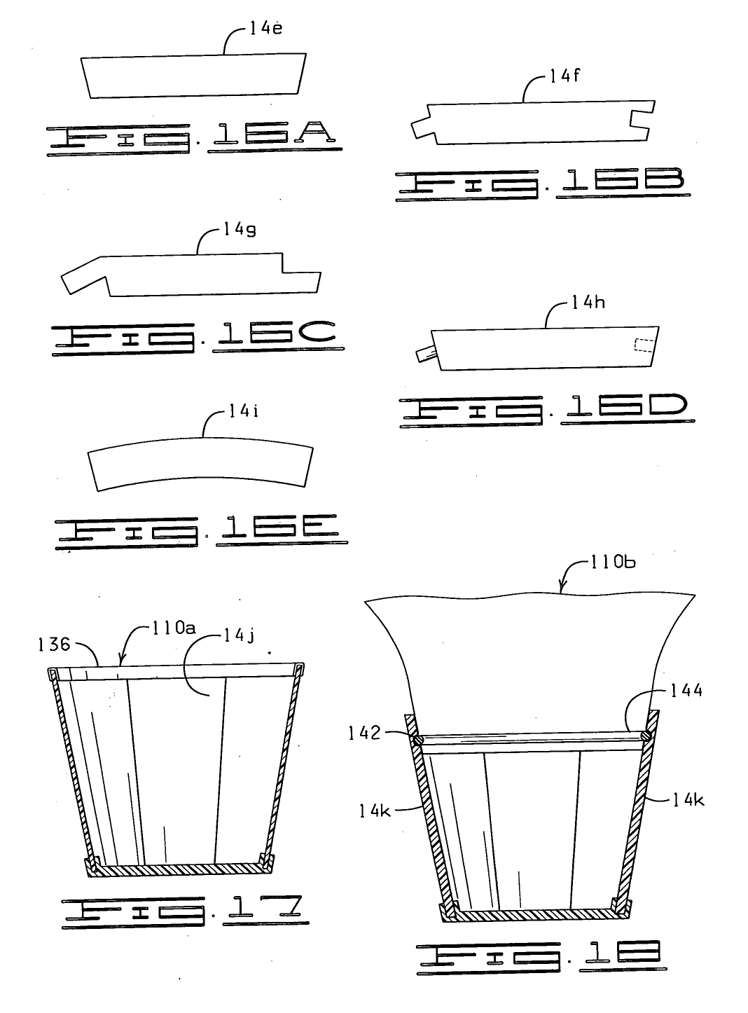

FIG. 15 shows a sectional view of a pot assembly 110. The pot assembly 110 includes a base member 112 having a bottom surface 114, a top surface 116, and a groove 118 formed along an outer perimeter thereof. The pot assembly 110 further includes a plurality rigid segments 14d having one end removably disposed in the groove 118 of the base member 112 arranged circumferentially about the base member 112 to form a sidewall 120. The sidewall 120 cooperates with the base member 112 to define an object receiving space 122. Each rigid segment 14d has a lower edge 124, an upper edge 126, a first side edge 128, and a second side edge 130. The first side edge 128 of each rigid segment 14d is detachably linked to the second side edge 130 of an adjacent rigid segment 14d with the rigid segments 14d disposed in the groove 118 of the base member 112. The first side edge 128 of each rigid segment 14d has a tongue 132 and the second side edge 130 of each rigid segment 14d has a groove 134 for receiving the tongue 132 of the adjacent rigid segment 14d.

As shown in FIG. 17, a pot assembly 110a includes an annular clip 136 positioned over the upper edge of rigid segments 14j so as to link each of the rigid segments 14j together. As shown in FIG. 20, the annular clip 136 can also be utilized to secure a flexible sheet of material 138 having a portion secured between the upper edge of the rigid segments 14j and the annular clip 136 and another portion extending from the rigid segments 14j so as to define a skirt 140. Another annular clip 136 can be secured to the lower edges 124 of the rigid segments 14j in substitution of the base member 112 to provide an open bottom container. Instead of a single clip, a plurality of clips 136a can be used to link the rigid segments 14j as illustrated in FIG. 21.

In another embodiment of a pot assembly 110b, as shown in FIG. 18, rigid segments 14k have a groove 142 formed on an interior surface thereof which is alignable with the grooves of the other rigid segments 14k to form and annular groove in the interior surface of the sidewall adapted to receive an elastic ring member 144 which is biased against the interior surface of the sidewall formed by the rigid segments 14k.

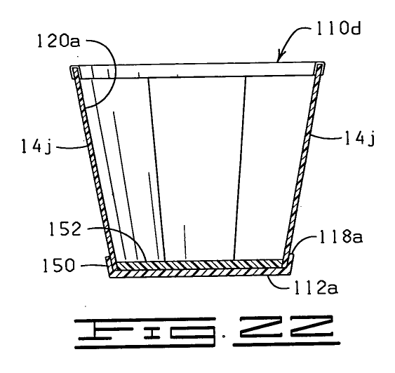

In yet another embodiment of a pot assembly 110c, as shown in FIG. 19, rigid segments 141 have a groove 142a formed on an exterior surface thereof which is alignable with the grooves of the other rigid segments 141 to form an annular groove in the exterior surface of the sidewall adapted to receive an elastic ring member 144a which is biased against the exterior surface of the sidewall formed by the rigid segments 141.

FIG. 22 illustrates another embodiment of another pot assembly 110d wherein a groove 118a is defined by a peripheral lip 150 of a base member 112a and an insert 152 positioned in a lower end of an object receiving space 120a. The insert 152 is dimensioned such that the lower edge of rigid segments 14j are supportingly received between the peripheral lip 150 of the base member 112a and a peripheral edge of the insert 152.

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A floral container, comprising:
a plurality of segments movable from a collapsed position to an expanded position wherein in the collapsed position all of the segments remain at least in part moveably connected such that each segment remains moveably connected to two other segments, at least a portion of the plurality of segments being rigid, wherein in the expanded position the segments form a sidewall and cooperate to define an object receiving space wherein the object receiving space is sized and shaped to receive at least one of a flower, a plant and a flower or plant support member, and wherein when the sidewall of the container is disposed in the collapsed position, an inner surface of each segment is disposed near an inner surface of another segment, and wherein the floral container is absent a waterproof liner disposed in the object receiving space thereof.

2. The floral container of claim 1 wherein the floral container has an open bottom.

3. The floral container of claim 1 further comprising a base member having a bottom surface and a top surface, wherein the base member forms a substantially closed lower end of the floral container.

4. The floral container of claim 1 wherein the floral container is provided with the object receiving space only when in the expanded position, and the floral container is not provided with an object receiving space when in the collapsed position.

5. The floral container of claim 1 wherein the segments are constructed of a material selected from the group consisting of ceramic, clay, concrete, plastic, metal, rock, and combinations thereof.

6. The floral container of claim 1 wherein each of the segments has an inner surface, an outer surface, and a first of longitudinal edge and a second longitudinal edge, and wherein each of the longitudinal edges is angled such that the first longitudinal edge of one segment abuttingly engages the second longitudinal edge of the adjacent segment in the expanded position.

7. The floral container of claim 1 wherein each of the segments has an inner surface, an outer surface, a first longitudinal edge, and a second longitudinal edge, and wherein the first longitudinal edge has an inner lip extending therefrom and the second longitudinal edge has an outer lip extending therefrom such that the inner lip of the first longitudinal edge overlaps the outer lip of the second longitudinal edge of an adjacent segment when the segments are in the expanded position.

8. The floral container of claim 1 wherein the segments have a substantially planar configuration.

9. The floral container of claim 1 wherein the segments have a substantially curved configuration.

10. The floral container of claim 1 further comprising a plurality of living hinges, wherein each living hinge has one portion connected to one of a first segment and another portion connected to a second segment adjacent the first segment.

11. The floral container of claim 1 wherein the first side edge of each segment has a tongue and the second side edge of each segment has a groove for receiving the tongue of an adjacent segment.

12. The floral container of claim 1 further comprising at least one annular clip positioned over the upper edge of the segments so as to link each of the segments together.

13. The floral container of claim 1 further comprising at least one elastic ring member positioned in the object receiving space and biased against the interior surface of the sidewall formed by the segments.

14. The floral container of claim 13 wherein each of the segments has a groove formed on an interior surface thereof which is alignable with the grooves of the other segments to form an annular groove in the interior surface of the sidewall adapted to receive the elastic ring member.

15. The floral container of claim 1 further comprising at least one elastic ring member biased against the exterior surface of the sidewall formed by the segments.

16. The floral container of claim 15 wherein each of the segments has a groove formed on an exterior surface thereof which is alignable with the grooves of the other segments to form an annular groove in the exterior surface of the sidewall adapted to receive the elastic ring member.

17. A floral container, comprising:
a plurality of segments movable from a collapsed position to an expanded position wherein in the collapsed position all of the segments remain at least in part moveably connected such that each segment remains moveably connected to two other segments, at least a portion of the plurality of segments being rigid, wherein in the expanded position the segments form a sidewall and cooperate to define an object receiving space wherein the object receiving space is sized and shaped to receive at least one of a flower, a plant and a flower or plant support member, and wherein when the sidewall of the container is disposed in the collapsed position, an inner surface of each segment is disposed near an inner surface of another segment; and
a sheet of material having a portion secured to at least a portion of the segments so as to define a skirt.

18. The floral container of claim 17 wherein the floral container has an open bottom.

19. The floral container of claim 17 further comprising a base member having a bottom surface and a top surface, wherein the base member forms a substantially closed lower end of the floral container.

20. The floral container of claim 17 wherein the floral container is provided with the object receiving space only when in the expanded position, and the floral container is not provided with an object receiving space when in the collapsed position.

21. The floral container of claim 17 wherein the segments are constructed of a material selected from the group consisting of ceramic, clay, concrete, plastic, metal, rock, and combinations thereof.

22. The floral container of claim 17 wherein each of the segments has an inner surface, an outer surface, and a first of longitudinal edge and a second longitudinal edge, and wherein each of the longitudinal edges is angled such that the first longitudinal edge of one segment abuttingly engages the second longitudinal edge of the adjacent segment in the expanded position.

23. The floral container of claim 17 wherein each of the segments has an inner surface, an outer surface, a first longitudinal edge, and a second longitudinal edge, and wherein the first longitudinal edge has an inner lip extending therefrom and the second longitudinal edge has an outer lip extending therefrom such that the inner lip of the first longitudinal edge overlaps the outer lip of the second longitudinal edge of an adjacent segment when the segments are in the expanded position.

24. The floral container of claim 17 wherein the segments have a substantially planar configuration.

25. The floral container of claim 17 wherein the segments have a substantially curved configuration.

26. The floral container of claim 17 further comprising a plurality of living hinges, wherein each living hinge has one portion connected to one of a first segment and another portion connected to a second segment adjacent the first segment.

27. The floral container of claim 17 wherein the first side edge of each segment has a tongue and the second side edge of each segment has a groove for receiving the tongue of an adjacent segment.

28. The floral container of claim 1 further comprising at least one annular clip positioned over the upper edge of the segments so as to link each of the segments together.

29. The floral container of claim 1 further comprising at least one elastic ring member positioned in the object receiving space and biased against the interior surface of the sidewall formed by the segments.

30. The floral container of claim 29 wherein each of the segments has a groove formed on an interior surface thereof which is alignable with the grooves of the other segments to form an annular groove in the interior surface of the sidewall adapted to receive the elastic ring member.

31. The floral container of claim 17 further comprising at least one elastic ring member biased against the exterior surface of the sidewall formed by the segments.

32. The floral container of claim 31 wherein each of the segments has a groove formed on an exterior surface thereof which is alignable with the grooves of the other segments to form an annular groove in the exterior surface of the sidewall adapted to receive the elastic ring member.
